(19) United States
(12) Patent Application Publication
(10) Pub. No.: US 2006/0154012 A1
(43) Pub. Date: Jul. 13, 2006

(54) All in one promotional mailer

(75) Inventors: Deb Ashton, Tonawanda, NY (US); Andre Saint, Getzville, NY (US); Blaine Jackson, East Aurora, NY (US)

Correspondence Address: CASELLA & HESPOS, 274 MADISON AVENUE, NEW YORK, NY, 10016, US

(73) Assignee: Avery Dennison Corporation, Pasadena, CA (US)

(21) Appl. No.: 11/032,454

(22) Filed: Jan. 10, 2005

(51) Int. Cl. B32B 33/00

(52) U.S. Cl. 428/40.1; 428/43

(57) ABSTRACT

A mailer includes first and second panels that are articulated to one another along a fold line. The fold line is configured to enable the first and second panels to be separated from one another. The first panel is formed from first and second sheets. Similarly, the second panel is formed from first and second sheets that are unitary respectively with the first and second sheets of the first panel. Adhesive-backed labels are formed on the first sheet of the first panel and can be separated from the second sheet. An envelope is formed by the first and second sheets of the second panel. The second panel may also include a return card that can be inserted into the envelope. The mailer can be printed with indicia specific to a targeted recipient.

### BACKGROUND OF THE INVENTION

1. Field of the Invention

The invention relates to an integral mailer and return envelope formed from a laminated sheet material.

2. Description of the Related Art

Many businesses and institutions solicit information and/or contributions from customers or other patrons. These solicitations often are distributed by mail and the customers or other patrons are encouraged to return the information or contribution by mail. A typical solicitation will include an outgoing mail envelope addressed to a particular recipient. One or more sheets of promotional or explanatory material may be inserted into the outgoing mail envelope along with a return envelope to be used by the recipient. The collating and insertion of materials into the primary envelope takes time and costs money.

Mass mailers typically insert generic material into the outgoing mail envelope. Thus, the inserts in each envelope will be identical regardless of the addressee identified on the outgoing mail envelope. Targeted mailings provide inserts in the outgoing mail envelope that are customized for the addressee. Thus, the information sent to one addressee will differ from the information directed to other addressees. Targeted mailing often is considered more effective than mass mailing, but also requires more careful control of the printing and insertion processes. Thus, targeted mailings often are performed by large commercial mailers with sophisticated printing and inserting equipment. Targeted mailings at a smaller scale generally require manual collating and inserting, and hence entail higher costs and lower speeds.

Personal computers and laser printers can be used with available software to print the inserts and envelopes for many mailings. However, the personal computers and laser printers generally do not solve all problems relating to collation and insertion. As a result, many small scale businesses and not-for-profit organizations rely upon manual collation and insertion of the targeted mailings produced with their personal computer and laser printer.

U.S. Pat. No. 6,517,921 is assigned to the assignee of the subject invention and the disclosure thereof is incorporated herein by reference. U.S. Pat. No. 6,517,921 discloses an assembly of sheets that are laminated in face-to-face relationship with one another. Portions of the sheets may be coated with an adhesive so that the sheets can be secured together. However, portions of the sheets may also be coated with a release layer so that selected areas of one sheet may be separated from the opposed sheet. One or both sheets may include an array of perforations and/or die cut lines disposed at specified locations with respect to the release coating. The arrangement of the release coating and the perforations or die cuts enables at least one part of at least one sheet to be separated from the remainder of the assembly of laminated sheets. Thus, for example, an identification card can be printed on a portion of one sheet and can be separated from the assembly of laminated sheets.

U.S. Pat. No. 6,149,205 also is assigned to the assignee of the subject invention and the disclosure thereof is incorporated herein by reference. U.S. Pat. No. 6,149,205 shows a sheet assembly formed to define an envelope that can be incorporated into a brochure or binder. A pressure sensitive adhesive is applied to the sealing flap of the envelope and is covered by a removable strip to protect the adhesive. Perforation lines permit the envelope to be separated from the brochure. The removable strip then is separated from the sealing flap so that the envelope can be sealed in a closed condition.

### SUMMARY OF THE INVENTION

The invention relates to an all-in-one mailer configured for mailing to a targeted addressee. The mailer is formed from a plurality of sheets of material laminated in substantially face-to-face engagement over at least portions of opposed facing surfaces of the sheets. The sheets of material are substantially co-extensive with one another so that the assembly of sheets is substantially coplanar and of substantially uniform thickness. As a result, the assembly of sheets can be processed efficiently in a laser printer or similar home or office apparatus.

The assembly preferably comprises a first sheet with opposite inner and outer surfaces and a second sheet with opposite inner and outer surfaces. The sheets are arranged so that the inner surface of the first sheet is opposed to the inner surface of the second sheet. A layer of adhesive preferably is applied to at least a portion of the inner surface of at least one sheet, and a release coating preferably is applied to portions of the inner surface of at least one sheet. The adhesive enables the inner surface of the one sheet to be secured in face-to-face engagement with the inner surface of the other sheet or with any other surface against which the inner surface is placed. The release coating prevents the adhesive from permanently affixing to the opposed sheet at locations where the release coating is applied.

The assembly further includes lines of weakness, such as arrays of perforations or die cuts at selected locations on the sheets. The perforations, die cuts or other such lines of weakness enable portions of the sheets to be severed and/or separated from one another. At least some of the perforations in the first sheet substantially register with perforations in the second sheet. These registered arrays of perforations define a fold line and enable a first multi-ply panel to be separated from a second multi-ply panel. However, some of the die cut arrays or perforation arrays do not register with an opposed array of die cuts or perforations. These latter arrays of die cuts or perforations may be applied to substantially register with areas of the assembly that have the release coating. This combination enables portions of one sheet to be peeled away from portions of the opposed sheet to reveal an adhesive flap or label.

The distribution of the perforations preferably is disposed to permit the entire assembly to be folded substantially in half so that the first sheet is surrounded by the second sheet. Edges of the folded sheets opposite the fold can be secured to one another by an adhesive tab or label. The outer surface of the second sheet thus defines an outer surface of this folded assembly and can be printed with indicia to define the address of a targeted person to whom the mailer will be sent. The addressee can separate the tab, label or other attachment and open the assembly to its unfolded disposition.

The perforations that permit the assembly to be folded in half can be sufficiently close to one another so that the assembly can be severed along the perforations. Thus, the sheet assembly is separated into the above-referenced first and second multi-ply panels. The release coating and/or the adhesive preferably are disposed so that a portion one multi-ply panel of the sheet assembly defines a return envelope. The perforation arrays may be disposed so that the return envelope can be severed from the remainder of the sheet assembly. A portion of the return envelope may define a sealing flap and may be covered by a removable strip that is coated with the release coating. Thus, the removable strip can be peeled from the sealing flap to expose a pressure sensitive adhesive, and the sealing flap can be folded into face-to-face relationship with an adjacent part of the return envelope to seal the return envelope. A portion of the return envelope may be preprinted with an address and a return address corresponding to the addressor and addressee of the outgoing mail envelope.

The sheet assembly may further include an array of perforations to define a return card that may be separated from remaining parts of the sheet assembly. The return card preferably is dimensioned to be inserted into the return envelope. Additionally, the return card may be printed with information relevant to the particular mailing, including targeted data.

Portions of a sheet with the adhesive coating may be formed with an array of die cuts so that areas bound by the die cuts can be severed from remaining portions of the sheet. The die cuts may extend through only one of the sheets and may be formed through portions of the sheet that are registered with the release coating. Thus, areas of the sheet bound by the die cuts may be peeled form the opposed sheet due to the release coating on the opposed sheet. This removed section of the sheet defines an adhesive-backed label or sticker that can be applied to another surface. Printing may be applied to the adhesive-backed sheet so that the adhesive-backed section removed from the sheet can function as a mailing label or return address label. A plurality of such printed labels can be disposed substantially adjacent one another and may function as a promotional item. The receipt of these promotional items may encourage the addressee of the assembly to use the return card and the return envelope.

### BRIEF DESCRIPTION OF THE DRAWINGS

FIG. 1 is an exploded perspective view of an assembly in accordance with the invention as viewed from the top of the assembly.

FIG. 2 is an exploded perspective view of the assembly as viewed from a side of the assembly opposite from the view shown in FIG. 1.

FIG. 3 is a perspective view of the assembly in the orientation shown in FIG. 1.

FIG. 4 is a perspective view that shows the assembly in a folded and ready-to-mail condition.

FIG. 5 is a perspective view of the assembly in an open and severed condition.

FIG. 6 is a perspective view of one-half of the assembly showing an insert card partly inserted into an envelope defined by the assembly.

FIG. 7 is a perspective view showing the insert card completely inserted in the envelope and with the removable strip partly severed from the flap of the envelope.

FIG. 8 is a perspective view showing the envelope in a fully sealed condition.

FIG. 9 is an exploded perspective view similar to FIG. 1, but showing an alternate embodiment.

FIG. 10 is a perspective view similar to FIG. 2, but showing the alternate embodiment.

FIG. 11 is a perspective view similar to FIG. 3, but showing the alternate embodiment.

FIG. 12 is a perspective view similar to FIG. 4, but showing the alternate embodiment.

FIG. 13 is a perspective view similar to FIG. 5, but showing the alternate embodiment.

FIG. 14 is a perspective view similar to FIG. 6, but showing the alternate embodiment.

FIG. 15 is a perspective view similar to FIG. 7, but showing the alternate embodiment.

FIG. 16 is a perspective view similar to FIG. 8, but showing the alternate embodiment.

FIG. 17 is a top plan view of an assembly similar to the assembly of FIGS. 1-8, but showing the respective mailers interconnected for processing in a printing apparatus.

### DETAILED DESCRIPTION OF THE PREFERRED EMBODIMENTS

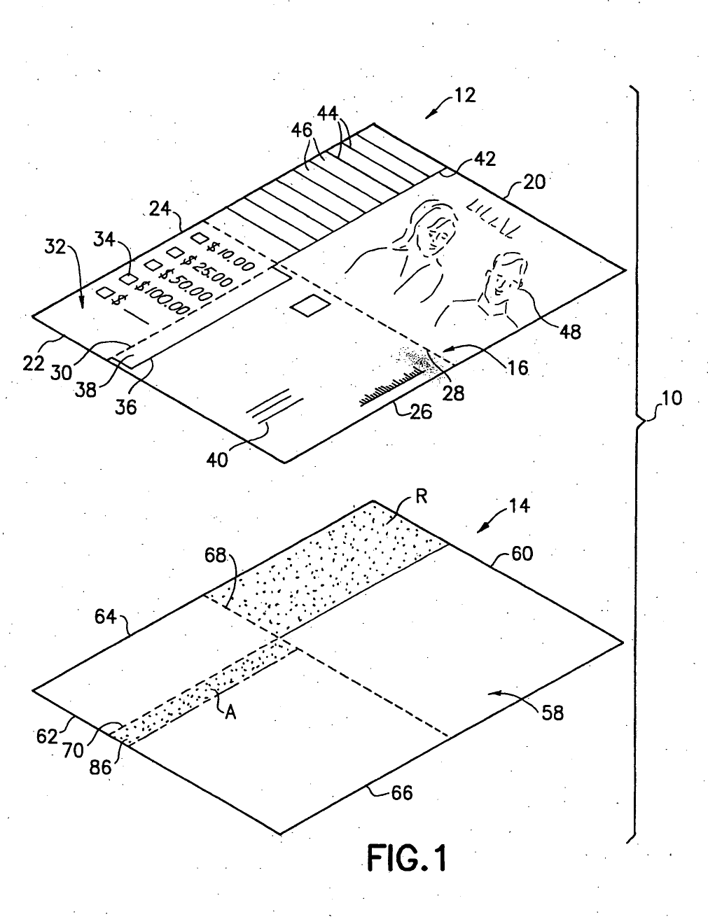

A mailer assembly in accordance with a first embodiment of the invention is identified generally by the numeral 10 in FIGS. 1-8. The assembly 10 includes first and second sheets of material 12 and 14 respectively. The sheets 12 and 14 are substantially rectangular and of substantially identical dimensions. Preferably, the sheets 12 and 14 are of standard dimensions that can be handled conveniently by a commercially available office or home printer, such as a laser printer or inkjet printer. For example, each sheet 12 and 14 may have a short dimension of approximately 8.5 inches and a long dimension of approximately 11 inches. Alternatively the sheets may have a short dimension of 11 inches and a long dimension of 17 inches. These respective dimensions correspond to standard sizes of sheet material used in the United States. However, the sheets 12 and 14 can be of the A3, A4 or A5 sizes used more widely in areas of the world that use metric dimensions. The sheets 12 and 14 preferably are formed from a paper or paperboard with a thickness that permits processing by a typical home or office printer and that meets the requirements of the United States Postal Service. For example, paper with a thickness in a range of 4-10 mils, and preferably 6.0 mils, is suitable for use in the assembly 10. In this regard, the overall thickness of the assembly 10 should be selected to ensure proper processing in the printing equipment that is likely to be employed by the consumer. Most commercially available laser printers work well with sheet material having a thickness of 15 mils or less. However, the overall thickness of the assembly 10 can exceed 15 mils for printers that can process thicker sheets or printers that become available for processing thicker sheets. The sheets 12 and 14 may be part of two rolls (not shown) so that a chain of interconnected assemblies 10 can be printed in a high speed printing apparatus. Alternatively, the assemblies 10 can be separated prior to printing.

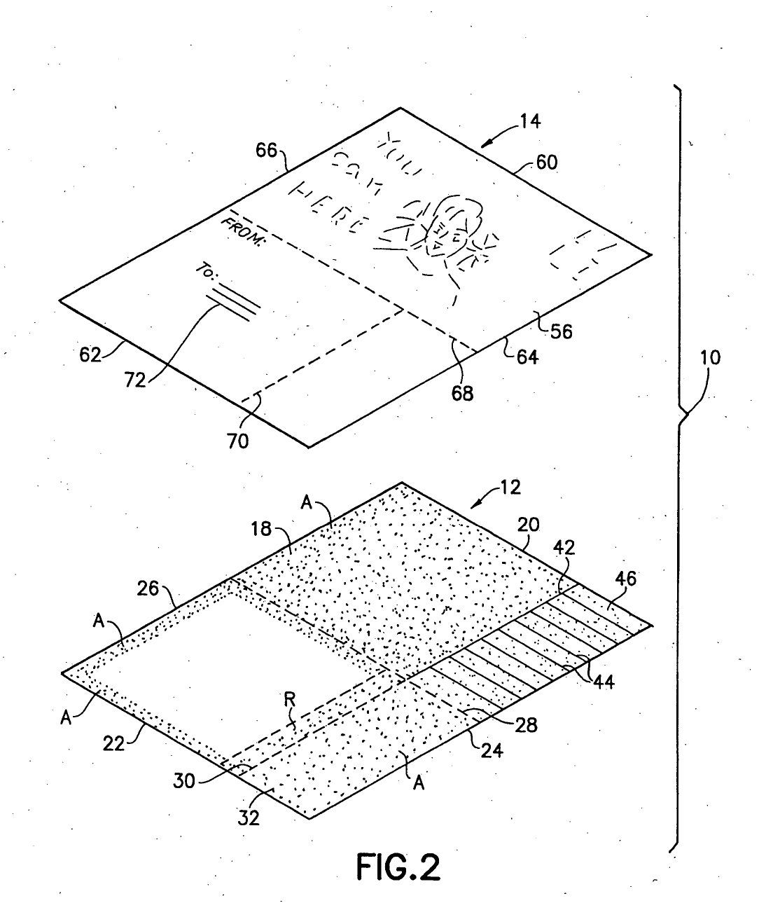

The first sheet 12 has an outer surface 16 as shown in FIG. 1 and an inner surface 18 as shown in FIG. 2. Additionally, the first sheet 12 includes opposed parallel short edges 20 and 22 and opposed parallel long edges 24 and 26. A fold line 28 extends substantially perpendicularly between the long edges 24 and 26 and substantially equidistant between the short edges 20 and 22. The fold line 28 is defined by an array of microperforations. The microperforations preferably have lengths of 0.0900-0.1000 inch and preferably 0.09375 inch. The spacing between the microperforations preferably will be 0.0250-0.0350 inch and preferably about 0.03125 inch. However these dimensions may vary depending upon the paper selected for the first sheet 12. More particularly, the perforations of the fold line 28 are provided to prevent tearing along the fold line 28 in response to an initial fold of the first sheet 12. However, the length and spacing of the microperforations along the fold line 28 is selected to permit the opposed halves of the first sheet 12 to be severed in response to tearing or pulling forces on sections of the first sheet 12 on opposite sides of the fold line 28. A microperforation density of about 5-15 per inch and most preferably 8 per inch generally is acceptable to achieve these requirements.

The microperforations disclosed herein represent one of many optional arrangements for forming a line of weakness. However, lines of weakness can be formed in many other ways known to those skilled in this art, including perforations, microperforations, partial die cuts and score lines on one or both sides of a sheet. The line of weakness preferably is created to achieve an easy and clean separation along the line of weakness. The edge of the separated sheet preferably has a clean appearance with no readily visible evidence of roughness, fuzziness or stretching. The die cut can be a cylinder-profile die cut or a flat-die cut. Additionally, the lines of weakness can be achieved by mechanical apparatus or a laser die cutting apparatus. A laser die cutting apparatus adjusts the power level of a laser to make cuts in a moving web. Perforations can be made with a laser die cutting apparatus by controlling the pulse period of the laser to make a series of alternating cuts and ties.

A perforation array 30 extends perpendicularly from the fold line 28 to the short edge 22 of the first sheet 12. The perforation array 30 preferably is closer to the long edge 24 than to the long edge 26. The density of perforations in the perforation array 30 is selected to provide relatively easily separation along the perforation array 30. This density will depend upon the type of paper employed for the first and second sheets 12 and 14. However, a density of about 30 per inch generally will be acceptable. The portion of the first sheet 12 bounded by the fold line 28, the perforation array 30, the short edge 22 and the long edge 24 defines a return card 32. The portion of the return card 32 defined by the outer surface 16 of the first sheet 12 may be imprinted with indicia 34, such as indicia to identify pledge amounts.

A tie line 36 extends substantially parallel to the perforation array 30 at a location between the perforation array 30 and the long edge 26. The tie line 36 includes relatively long perforations (e.g., 1 inch) and relatively short ties between the perforations. Portions of the first sheet 12 between the perforation array 30 and the tie line 36 define a removable strip 38. Portions of the first sheet 12 bounded by the short edge 22, the long edge 26, the fold line 28 and the tie line 36 are imprinted with indicia 40 including an address, a return address of the targeted recipient and/or return postage.

The first sheet 12 further includes an elongate die cut 42 extending substantially linearly from the perforation array 30 between the short edge 20 and the fold line 28. Additionally, a plurality of transverse die cuts 44 extend between the elongate die cut 42 and the long edge 24 of the first sheet 12. The die cuts 42 and 44 define a plurality of return address labels 46. Return address indicia is printed on portions of the first surface 16 defining the respective return mailing labels 46 and corresponds to the address of the targeted recipient. Additional promotional indicia 48 is provided on portions of the first surface 16 bounded by the short edge 20, the long edge 26, the fold line 28 and the elongate die cut line 42.

The second sheet 14 includes an outer surface 56 as shown in FIG. 2 and an inner surface 58 as shown in FIG. 1. Additionally, the second sheet 14 includes parallel short edges 60 and 62 and parallel long edges 64 and 66. A fold line 68 extends perpendicularly between the long edges 64 and 66 and substantially equidistant from the short edges 60 and 62. The fold line is defined by an array of microperforations similar to the microperforations of the fold line 28. A perforation array 70 extends perpendicularly between the short edge 62 and the fold line 68. The perforation array 70 preferably is substantially identical to the perforation array 30 of the first sheet 12. Additionally, the perforation arrays 30 and 70 are disposed to substantially register with one another when the first and second sheets 12 and 14 are registered with one another. Portions of the outer surface 56 of the second sheet 14 bounded by the short edge 62, the long edges 64 and 66 and the fold lines 68 include indicia 72 to identify the address of the targeted recipient. Additionally, portions of the outer surface 56 between the short edge 60 and the fold line 68 have promotional indicia 74.

The inner surface 18 of the first sheet 12 preferably has an adhesive A applied substantially entirely over the area of inner surface 18 bounded by the short edge 20, the long edges 24 and 26 and the fold line 28. Adhesive A also is applied to portions of the inner surface 58 of the second sheet 14 that defines a flap 86 bounded by the short edge 62, the perforation array 70, the fold line 68 and an area registered with the tie line 36. Adhesive A further is applied along narrow strips adjacent the short edge 22, the long edge 26 and the fold line 28. However, no adhesive is applied at interior portions spaced from the short edges 22 or 62, the long edges 26 or 66, the fold lines 28 or 68 and the tie line 36.

The inner surface 58 of the second sheet 14 has a release coating R, such as silicone products available from General Electric and other companies, applied in an area inwardly of the short edge 60, the long edge 64 and the fold line 68. Fluorinated or amine-based release coatings also may be used. The release coating preferably is very thin and most preferably 0.1-0.5 mils. The release coating R is disposed to substantially register with the return mailing labels 46 when the sheets 12 and 14 are placed in registration with one another. The release coating R also is applied to an area on the inner surface 18 of the first sheet 12 between the short edge 22, the fold line 28 and adjacent to the tear line 30 and the tie line 36. Thus, the release coating R is on the removable strip 38 of the first sheet 12, and hence on an area registered with the flap 86. The above-described disposition of adhesive and release coating can be reversed with minor changes to the pattern of perforations. Thus, the area 38 could be the sealing flap and the area 86 could be the removable strip. This alternate is considered in the second embodiment described below.

The inner surfaces 18 and 58 of the first and second sheets 12 and 14 are disposed in face-to-face engagement with one another so that the sheets 12 and 14 are registered. The adhesive A applied to the inner surfaces 18 and 58 then is activated to secure the adhesive A to the first and second sheets 12 and 14 together. The activation of the adhesive A can be achieved by appropriate application of heat and/or pressure, depending upon the characteristics of the adhesive A. The adhesive preferably should not flow at temperatures encountered in a laser printer or other high temperature printer. Stability at 300° F.-400° F. is preferable. One such adhesive is described in U.S. Pat. No. 5,262,216, the disclosure of which is incorporated herein by reference. A suitable adhesive is the general purpose permanent hot melt adhesive available from Avery Dennison Corporation, and such an adhesive preferably is applied to a thickness of between 0.25-1.50 mils. The adhesive A achieves a substantially permanent affixation of the first and second sheets 12 and 14 across areas that do not register with the release coating R. Additionally, the sheets 12 and 14 do not adhere to one another at locations inwardly from the registered short edges 22, 62, the registered long edges 26, 66, the registered fold lines 28, 68 and the tie line 36 where no adhesive has been applied.

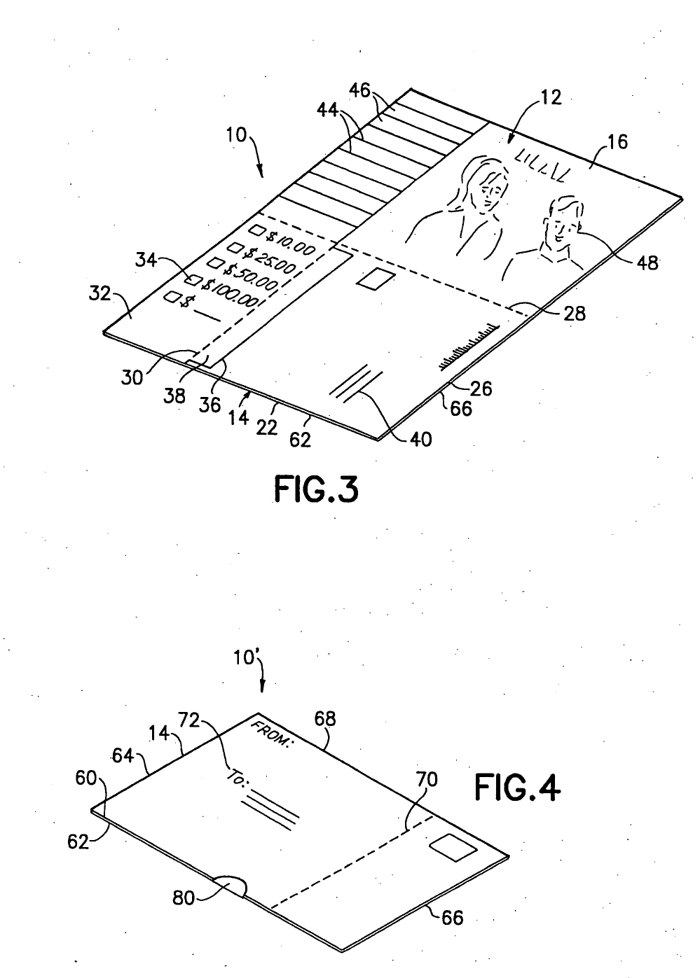

The sheets 12 and 14 preferably are secured together as described above prior to printing the indicia 34, 40, 48, 72 and 74 thereon. Rather, a plurality of the mailers 10 shown in FIG. 3 may be processed through a laser printer or other such printing apparatus that communicates with a computer to apply printed indicia pursuant to instructions input by a user in accordance with an appropriate software program. The address information on the outer surface 56 of the second sheet 14 and the return address information on the return mailing labels 46 preferably is dedicated to a targeted recipient of the mailer 10. Other information, however, may be more generic and may be identical for a plurality of the assemblies 10. As an alternative, a plurality of the mailers 10 may be chained along perforation arrays (e.g., at short edges 20, 22, 60, 62) and may be fed through a printer for subsequent separation.

The mailer 10 is used as shown in FIGS. 4-8. In particular, the sheets 12 and 14 of the mailer 10 are folded about the registered fold lines 28 and 68 so that the short edges 20, 22, 60 and 62 substantially register with one another. An adhesive tab 80 then is applied across the registered short edges 20, 22, 60, 62 to retain the mailer 10 in the folded condition shown in FIG. 4. As shown in FIG. 4, the address of the targeted recipient 72 and other indicia is exposed on the outer surface 56 of the second sheet 14.

The recipient uses the mailer 10 by first severing the tab 80 and folding the assembly from the FIG. 4 condition back to the FIG. 3 condition. The indicia 34, 40 and 48 depicted on the outer surface 16 of the first sheet 12 will be visible to the targeted recipient of the assembly 10. The recipient then is encouraged by instructions among the indicia to sever the assembly 10 along the registered fold lines 28 and 68 to define first and second multi-ply panels 82 and 83. The first multi-ply panel 82 shown in FIG. 5 then is retained by the targeted recipient and the return mailing labels 46 are removed periodically by the recipient and used on mail sent by the recipient. In this regard, the release coating R on the inner surface 58 of the second sheet 14 enables the respective return mail labels 46 to be peeled separately from the first multi-ply panel 82. The pressure sensitive adhesive on the inner surface 18 of the first sheet 12 enables the individual return mail labels 46 to be applied to the targeted recipient's envelopes. The indicia 78 will remain on the panel 82 to periodically reinforce the message intended by the initial sender of the assembly 10.

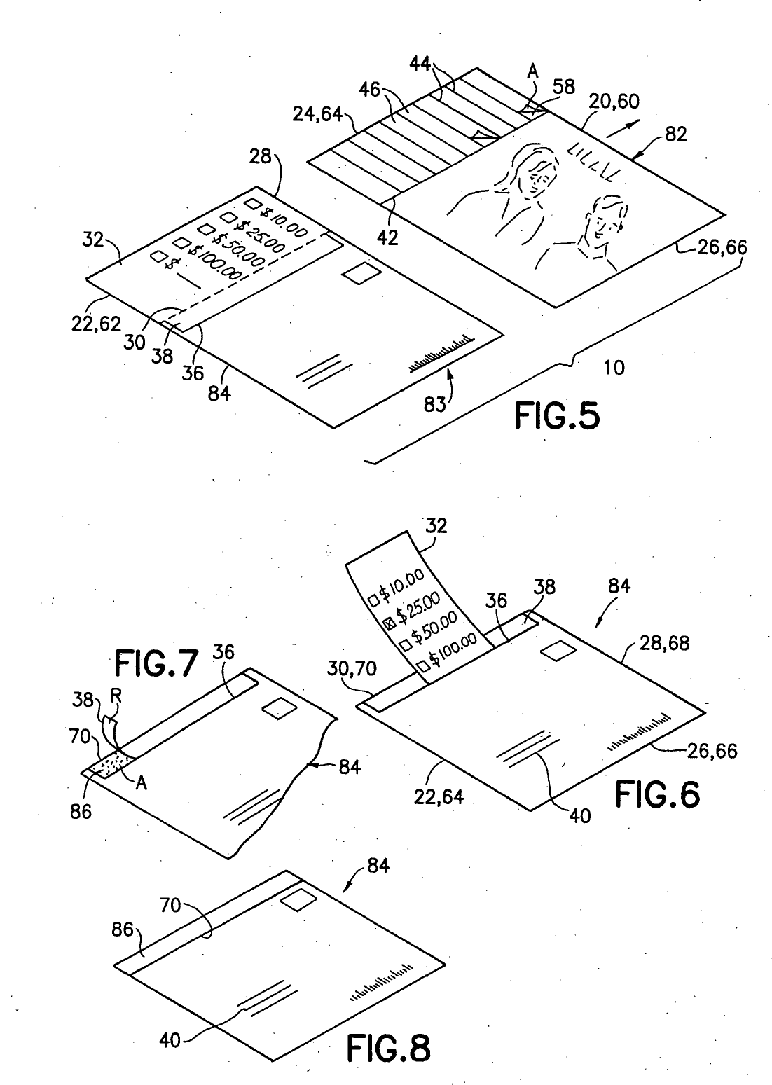

The indicia 34 on the return card 32 encourages the recipient to make a donation to the originator of the mailer 10. Thus, the recipient tears the return card 32 along the perforation array 30 and marks an appropriate donation amount on the indicia 34. The remaining portion of the mailer 10 defines an envelope 84 as shown in FIGS. 6-8. More particularly, the interior of the envelope is accessible adjacent to the removable strip 38 due to the absence of adhesive at locations inwardly from the area bounded by the short edges 22, 62, the long edges 26, 66 and the fold lines 28, 68. The recipient slides the marked return card 32 into the envelope 84. The removable strip 38 then is separated from the envelope 38 by pulling the removable strip 38 as shown in FIG. 7. Portions of the second sheet 14 beneath the removable strip 38 define a sealing flap 86 that can be folded over so that the adhesive secures the flap 86 to the first sheet 12. The return address of the originator of the mailer 10 is printed as part of the indicia 40 on the envelope 84. The recipient then merely deposits the envelope 84 in a mailbox or other postal receptacle.

The mailer 10 has several desirable advantages. First, the indicia on the outer surfaces 16 and 56 can be printed readily with a home or office printer to create a targeted mailing for use by small or large organizations, including not-for-profit businesses and commercial mailers. The return mail labels 46 provide an incentive for the recipient to respond favorably to a request for a donation. Additionally, the solicitation provided by the indicia 48 serves as a reminder to the recipient while the recipient gradually exhausts the supply of return labels 46.

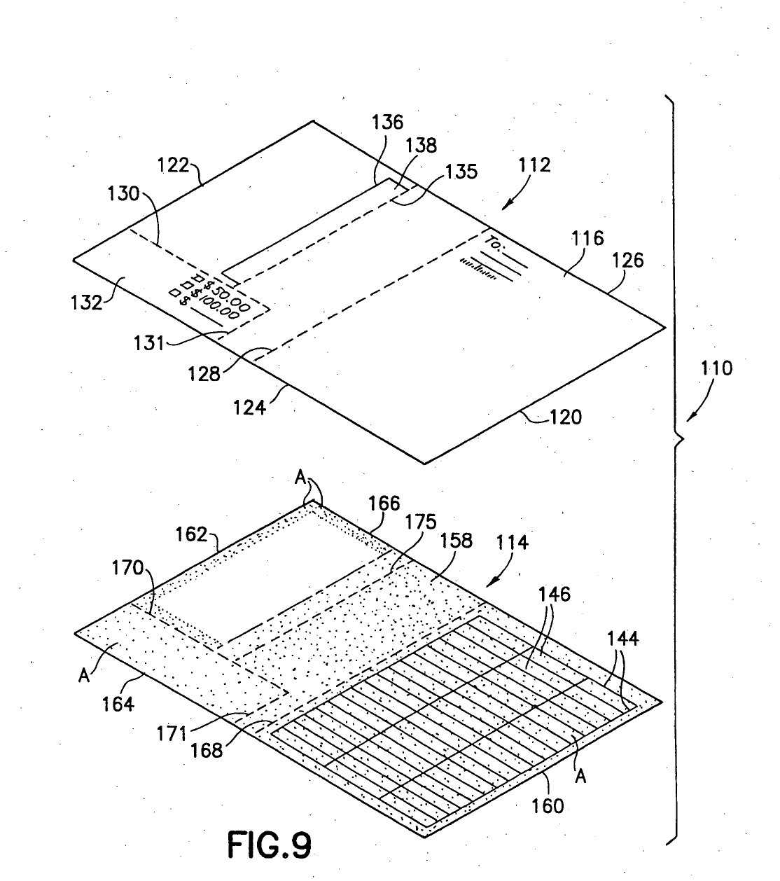

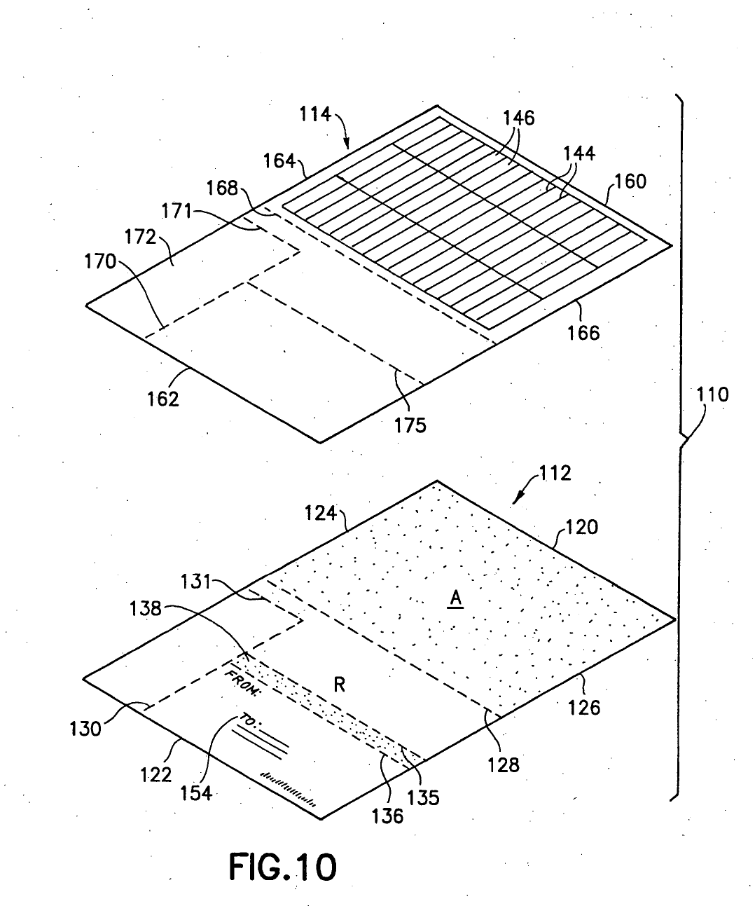

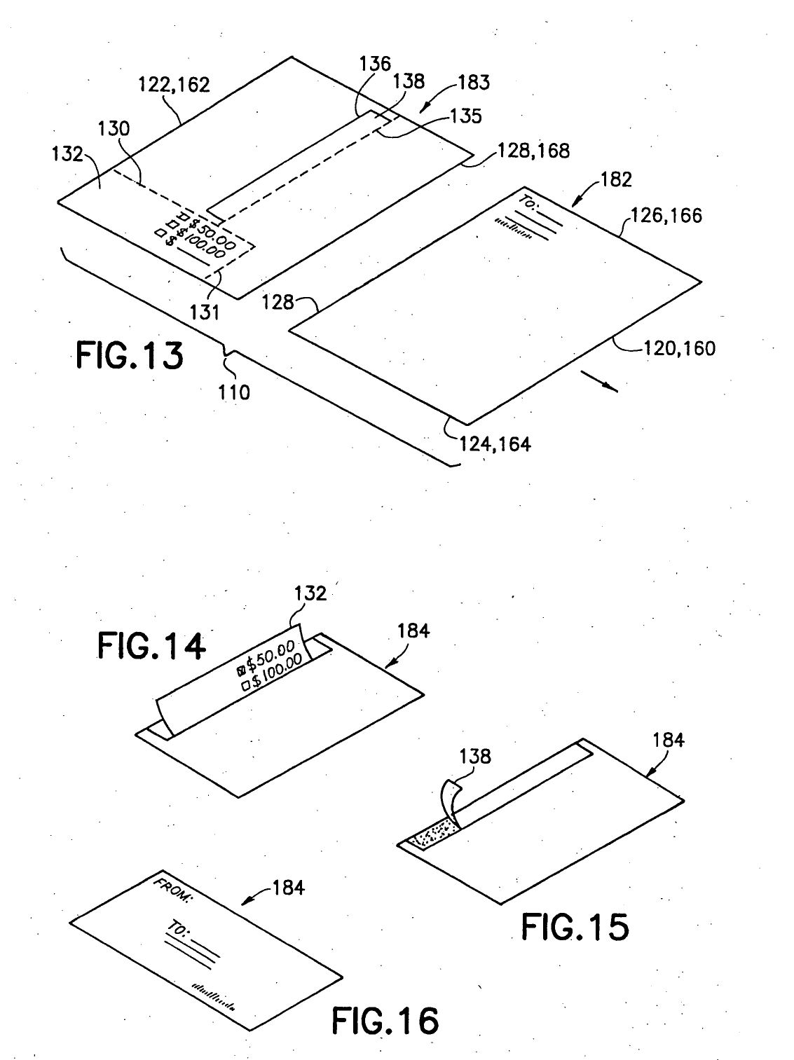

An alternate all-in-one mailer assembly in accordance with a second embodiment of the invention is identified generally by the numeral 110 in FIGS. 9-16. The assembly 110 is structurally and functionally very similar to the assembly 10 described above and illustrated in FIGS. 1-8. In this regard, the assembly 110 includes first and second sheets 112 and 114. The first sheet 112 is substantially rectangular and includes an outer surface 116 and an inner surface 118. The first sheet 112 includes opposite short edges 120 and 122 and opposite long edges 124 and 126. As illustrated, the assembly 110 is intended to be larger than the assembly 10 described above. However, the relative dimensions are not critical. A fold line 128 extends across the first sheet between the long edges 124 and 126 and substantially equidistant from the short edges 120 and 122. A first return card tear line 130 extends from the short edge 122 towards the fold line 128 and a second return card fold line 131 that extends orthogonally between the long edge 124 and the first return card tear line 130. The area bounded by the short edge 122, the long edge 124 and the tear lines 130 and 131 defines a return card 132 that includes indicia 134 to identify recommended contribution levels. An envelope tear line 135 extends orthogonally between the long edge 126 and the first return card tear line 130. A tie line 136 extends parallel to the envelope tear line 135 and the short edge 122 to define a removable strip 138 that is functionally similar to the removable strip 38 of the first embodiment.

Other indicia is provided on the outer surface 116 of the first sheet 112, but with a different arrangement. In particular, indicia 140 identifies the address of the targeted recipient. Other indicia on the outer surface 116 of the first sheet 112 are intended to promote a donation or other commitment.

The second sheet 114 includes an outer surface 156 and an inner surface 158. Additionally, the second sheet 114 includes short edges 160 and 162 and long edges 164 and 166. A fold line 168 is disposed to register with the fold line 128. The second sheet 114 also includes tear lines 170, 171 and 175 disposed to register with the tear lines 130, 131 and 135 respectively. The second sheet 114 also includes a rectangular array of die cut lines 172 for defining return mailing labels 174. Indicia on the outer surface 154 of the second sheet 114 includes the name and mailing address of the targeted recipient of the assembly 110 on the respective mailing labels 174. Additionally, the address of the originator of the mailer 110 is provided in the area bounded by the short edge 162, the long edge 166, and the tear lines 170 and 175a. Pledge information or other requests for recipient-specific data is provided in the area bounded by the short edge 162, the long edge 164 and tear lines 170 and 171. Promotional information also may be provided in the area in proximity to the fold line 168.

Adhesive A preferably is provided along a major portion of the inner surface 158 of the second sheet 144. However, no adhesive is provided in the region inwardly from the short edge 162, the long edge 164 and the first return card tear line 170b. A release coating is provided on portions of the inner surface 118 of the first sheet 112 that will register with the return mail labels 174 and with the removable strip 138.

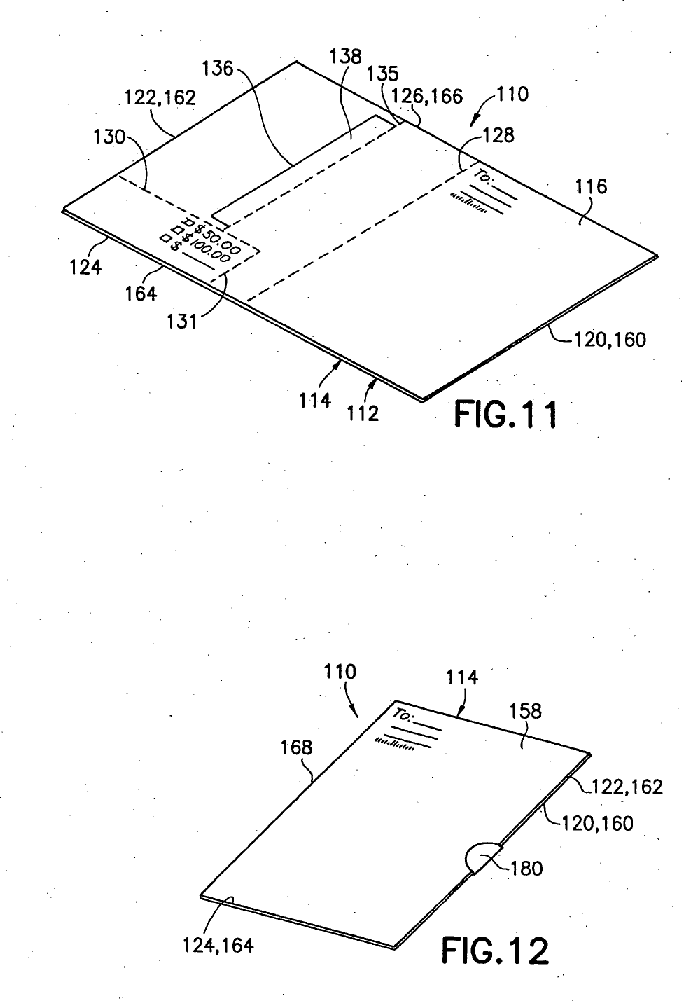

The mailer 110 is assembled into the condition shown in FIG. 11, substantially in the same manner as the mailer 10 described above. In particular, the inner surfaces 118 and 158 are placed in face-to-face relationship to one another. The adhesive then is activated by heat and/or pressure as described above. The mailer 110 then is folded from the FIG. 11 orientation into the FIG. 12 orientation and the registered short edges 112, 122, 160 and 162 are secured by one or more adhesive tabs 180. The recipient severs the tabs 180 and folds the mailer 110 from the FIG. 12 condition back to the FIG. 11 condition. The recipient then tears the mailer 110 along the registered fold lines 128, 168 to form separate multi-ply panels 182 and 183. The return mail labels 174 can be peeled from the first multi-ply panel 182, as needed substantially and as described above. The recipient then completes the requested indicia on the return mail label 132 and separates the return mail label from the envelope 184. The return card 132 then is inserted into the envelope 184. The removable strip 138 then is separated as shown in FIG. 15 and the sealing flap 186 is folded into secure engagement with the first sheet 114. The sealed enveloped then is mailed back to the originator of the mailer 110.

The mailer 110 differs from the mailer 10 described above and illustrated in FIGS. 1-8. In particular, adhesive is applied only to the inner surface 158 of the second sheet 114 and the release coating is applied only to the inner surface 118 of the first sheet 112. Thus, the application of coatings can be simplified.

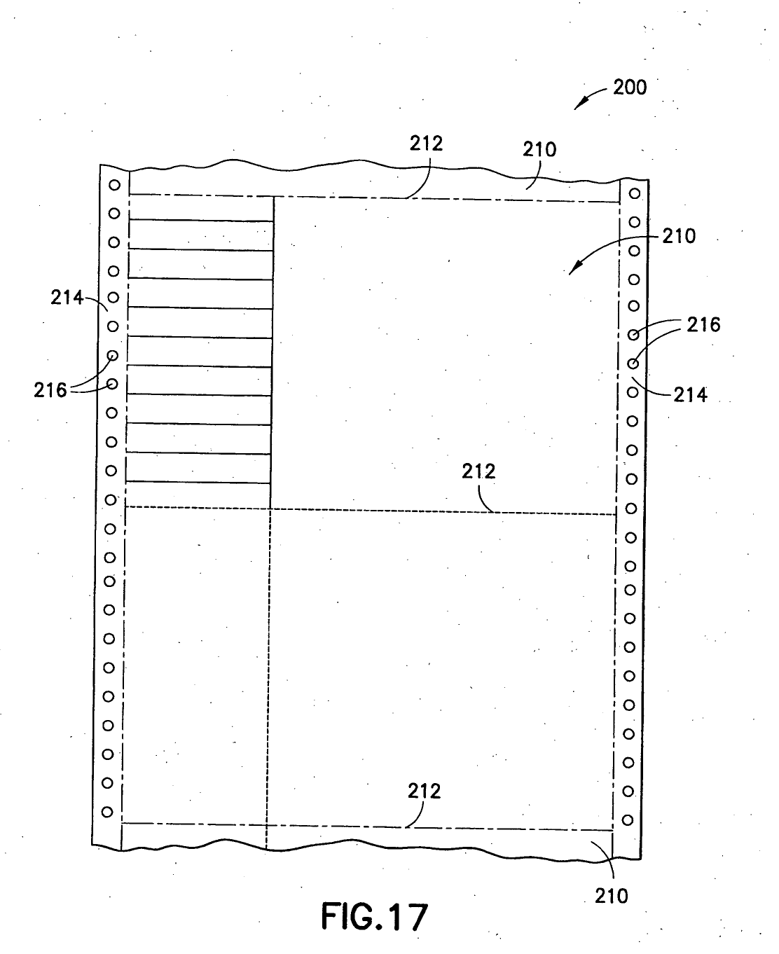

The mailers 10 and 110 described and illustrated above are intended for processing sequentially in a conventional sheet-fed home or office printer. However, the mailer can be chain fed into a printing apparatus. In this regard, FIG. 17 shows an assembly 200 with a plurality of mailers 210 sequentially connected to one another along parallel lines of weakness 212, such as the above-described die cut perforation arrays or other lines of weakness. Additionally, the assembly 200 includes removable strips 214 with apertures 216 for feeding the assembly 200 through a printer. The removable strips 214 can be separated and discarded or recycled. The mailers 210 then can be separated from one another for distribution.

The invention has been described with respect to certain preferred embodiments. However, variations will be appreciated by those skilled in the art after having read the subject disclosure. For example, the disposition and nature of the indicia on the mailers can be varied significantly from the arrangement of indicia shown in the figures. The mailers 10 and 110 also can be used for many purposes other than soliciting contributions. For example, mailers of this type are well suited for encouraging targeted recipients to volunteer for committees of an organization. Committees can be selected by the targeted recipient and returned to an organization in the return envelope. The adhesive-backed labels need not be return mail labels. For example, labels that promote a particular political or social cause can be provided to the targeted recipient. Stickers that are intended to be affixed to a government license or a membership card also can be provided. Still further, the size and orientation of the return envelope and/or a return card can vary widely in accordance with the size of the paper and the particular targeting mailing objective. These and other variations are encompassed by the scope of the invention as defined by the appended claims.

What is claimed is:

1. A mailer comprising a first multi-ply panel and a second multi-ply panel articulated to one another along a fold line that has perforations for permitting separation of the first and second panels, the first multi-ply panel including a first sheet and a second sheet, at least a portion of the first sheet of the first multi-play panel having a pressure-sensitive adhesive applied thereto for securing portions of the sheets in face-to-face relationship, a release layer adjacent a portion of the pressure sensitive adhesive so that at least a portion of the first sheet of the first multi-ply panel is separable from the second sheet of the first multi-ply panel to define an adhesive-backed label, the second multi-ply panel being formed from first and second sheets adhered to one another at selected locations for defining an envelope and at least one insert separable from at least one of the panels and dimensioned for insertion into the envelope.

2. The mailer of claim 1, wherein at least one of the first and second sheets of the second panel defines a sealing flap articulated to the second panel, one surface of the sealing flap including an adhesive for permitting the sealing flap to seal the envelope, the other of the first and second sheets of the second panel including perforations for defining a removable strip covering the pressure sensitive adhesive of the sealing flap, the removable strip being provided with a release coating to facilitate separation of the removable strip from the sealing flap.

3. The mailer of claim 1, wherein the first sheet of the first panel is unitary with the first sheet of the second panel and wherein the second sheet of the first panel is unitary with the second sheet of the second panel.

4. The mailer of claim 3, wherein the first sheet of the first panel is formed to define a plurality of adhesive-backed labels that are separable from the second sheet of the first panel.

5. The mailer of claim 4, wherein the adhesive is applied to substantially all of a surface of the first sheet of the first panel facing the second sheet of the first panel and wherein the release coating is applied to at least portions of a surface of the second sheet of the first panel facing the adhesive-backed labels.

6. The mailer of claim 5, wherein the sealing flap of the envelope is formed unitarily with the first sheet of the second panel.

7. The mailer of claim 5, wherein the sealing flap of the envelope is formed unitarily with the second sheet of the second panel.

8. The mailer of claim 1, wherein the mailer is of substantially uniform thickness at al locations thereon.

9. A mailer comprising a first sheet having opposite inner and outer surfaces and a second sheet having opposite inner and outer surfaces, an adhesive being applied to selected portions of the inner surface of the first sheet for securing the selected portions of the inner surface of the first sheet to the inner surface of the second sheet, portions of the inner surface of the second sheet having a release coating applied thereto for permitting a local separation of the first and second sheets from one another, portions of the first sheet opposed to the release coating being die cut to define a plurality of adhesive-backed labels that are separable from the second sheet, portions of the inner surfaces of the first and second sheets being substantially unsecured to one another for defining an envelope, perforations being formed through said sheets for separating said envelope from remaining portions of said mailer.

10. The mailer of claim 9, wherein the envelope include a sealing flap formed from one of said first and second sheets and being hingedly rotatable for closing the envelope, the sealing flap having an adhesive applied to a surface thereof for sealing the envelope in a closed-condition, a removable strip being formed unitarily with one of said sheets opposed to said flap and having a release coating applied thereto for facilitating separation of said removable strip from said sealing flap.
